(19) United States
(12) Patent Application Publication
(10) Pub. No.: US 2016/0206495 A1
(43) Pub. Date: Jul. 21, 2016

(54) POST-OPERATIVE COMPRESSION VEST AND METHOD FOR PROVIDING ADJUSTABLE COMPRESSION ACROSS A THORACIC REGION OF A SUBJECT

(71) Applicant: Joseph Simon Pongratz, Chandler, AZ (US)

(72) Inventor: Joseph Simon Pongratz, Chandler, AZ (US)

(21) Appl. No.: 14/602,030

(22) Filed: Jan. 21, 2015

(51) Int. Cl. A61H 1/00

(52) U.S. Cl. CPC A61H 1/008

(57) ABSTRACT

A post-operative compression vest for providing adjustable compression across a thoracic region of a subject. The thoracic region of the subject may include an abdominal-thoracic region. The compression vest may extend over and/or apply pressure to sections of the thoracic region of the subject. The compression vest may include one or more straps configured to wrap around sections of the thoracic region of the subject. In some implementations, a cinching mechanism may be coupled to the strap. The cinching mechanism may be configured to apply adjustable tension in the strap. Responsive to the compression vest being worn by the subject, the cinching mechanism may be configured such that a thoracic region of the subject is further compressed by the adjustable tension in the strap.

### FIELD

The disclosure relates to a post-operative compression vest and method for providing adjustable compression across a thoracic region of a subject.

### BACKGROUND

Compression garments for applying compression for sports, medical, and aesthetic reasons are known. Typically compression vests are difficult for a person to put on and apply one level of compression to a person's chest. Furthermore, the amount of compression typical compression vests apply is limited based on the size of the vest and the size of the person. Garments having straps across the chest are also known. Typically, when the garment is worn, the straps on these garments extend from one side of the chest to the other side of the chest. The purpose of straps across the chest on these garments typically is to suspend the garment on a person.

### SUMMARY

One aspect of the disclosure relates to a compression vest for providing adjustable compression across a thoracic region of a subject, in accordance with one or more implementations. The compression vest may extend over and/or apply pressure to sections of the thoracic region of the subject. Sections of the thoracic region may include one or more of a section of a back, a section of a front torso, a section of a left side torso, a section of a right side torso, a section of a left shoulder, a section of a right shoulder, and/or other sections of the thoracic region. The thoracic region of the subject may include an abdominal-thoracic region.

In some implementations, the compression vest may include one or more straps. Responsive to compression vest being worn by the subject, the strap may be configured to wrap around a section of the back, a section of the front torso, a section of the left side torso, a section of the right side torso, and/or other sections of the thoracic region of the subject. In some implementations, a cinching mechanism may be coupled to the strap. The cinching mechanism may be coupled to one or more given ends of the strap. The cinching mechanism may be configured to apply adjustable tension in the strap. Responsive to the compression vest being worn by the subject, the cinching mechanism may be configured such that a thoracic region of the subject may be further compressed by the adjustable tension in the strap.

In some implementations, the compression vest may include one or more portions. The portions may be joined, attached, and/or detachably coupled at one or more edges. The one or more portions may include one or more of a left front portion, a right front portion, a back portion, a band portion, and/or other portions. The one or more edges may include one or more of a left outer edge, a right outer edge, a left inner edge, a right inner edge, a left bottom edge, a right bottom edge, a left top edge, a right top edge, a first outer edge, a second outer edge, a back bottom edge, a first top edge, a second top edge, and/or other edges.

The right front portion may include one or more edges, for example, the right bottom edge, the right inner edge, the right outer edge, the right top edge, and/or other edges of the right portion. Responsive to the compression vest being worn by the subject, the right portion may extend over a section of a right side of the front torso, a section of the right side torso, a section of the right shoulder, and/or other sections of the subject. The left front portion may include one or more edges, for example, the left bottom edge, the left inner edge, the left outer edge, the left top edge, and/or other edges of the left portion. Responsive to the compression vest being worn by the subject, the left portion may extend over a section of a left side of the front torso, a section of the left side torso, a section of the left shoulder, and/or other sections of the subject. The left front portion may be configured to detachably couple to the right front portion at the left inner edge and the right inner edge.

The back portion may include one or more edges, for example, the first outer edge, the second outer edge, the back bottom edge, the first top edge, the second top edge, and/or other edges of the back portion. Responsive to the compression vest being worn by the subject, the back portion may extend over a section of a back, a section of a right side torso, a section of a left side torso, a section of a right shoulder, a section of a left shoulder of the subject, and/or other sections of the subject. The back portion may be configured to join the left front portion at the first outer edge and the left outer edge. The back portion may be configured to join the right front portion at the second outer edge and the right outer edge. The left front portion and/or the right front portion may be configured to detachably couple to the back portion at the left top edge, the right top edge, the first top edge, the second top edge, and/or other edges.

In some implementations, the compression vest may include the band portion. The band portion may be configured to join the back portion, the left front portion, the right front portion, and/or other portions. The band portion may be configured to join the back portion, the left front portion, the right front portion, and/or other portions at and/or near the back bottom edge, the left bottom edge, the right bottom edge, and/or other edges. Responsive to the compression vest being worn by the subject, the band portion may be configured to extend around the subject.

The strap may be coupled to the compression vest. The strap may be configured such that, responsive to the compression vest being worn by the subject, the strap wraps around a section of the back, a section of the right side torso, a section of the left side torso, a section of the front torso (e.g., the chest), and/or other sections of the subject. The cinching mechanism may be coupled to the first end and the second end of the strap. The cinching mechanism may be configured to apply adjustable tension in the strap. Adjustable tension may be applied in the strap such that responsive to the compression vest being worn by the subject, the strap and/or the cinching mechanism are configured to further compress a thoracic region of the subject.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1A illustrates a front view of a post-operative compression vest for providing adjustable compression across a thoracic region of a subject, in accordance with one or more implementations.

FIG. 1B illustrates a back view of a post-operative compression vest for providing adjustable compression across a thoracic region of a subject, in accordance with one or more implementations.

FIG. 2 illustrates an exemplary implementation of a post-operative compression vest for providing adjustable compression across a thoracic region of a subject, in accordance with one or more implementations.

FIG. 3 illustrates another exemplary implementation of a post-operative compression vest for providing adjustable compression across a thoracic region of a subject, in accordance with one or more implementations.

FIG. 4 illustrates another exemplary implementation of a post-operative compression vest for providing adjustable compression across a thoracic region of a subject, in accordance with one or more implementations.

FIG. 5 illustrates another exemplary implementation of a post-operative compression vest for providing adjustable compression across a thoracic region of a subject, in accordance with one or more implementations.

FIG. 6 illustrates a method for applying adjustable compression across a thoracic region of a subject using a post-operative compression vest, in accordance with one or more implementations.

### DETAILED DESCRIPTION

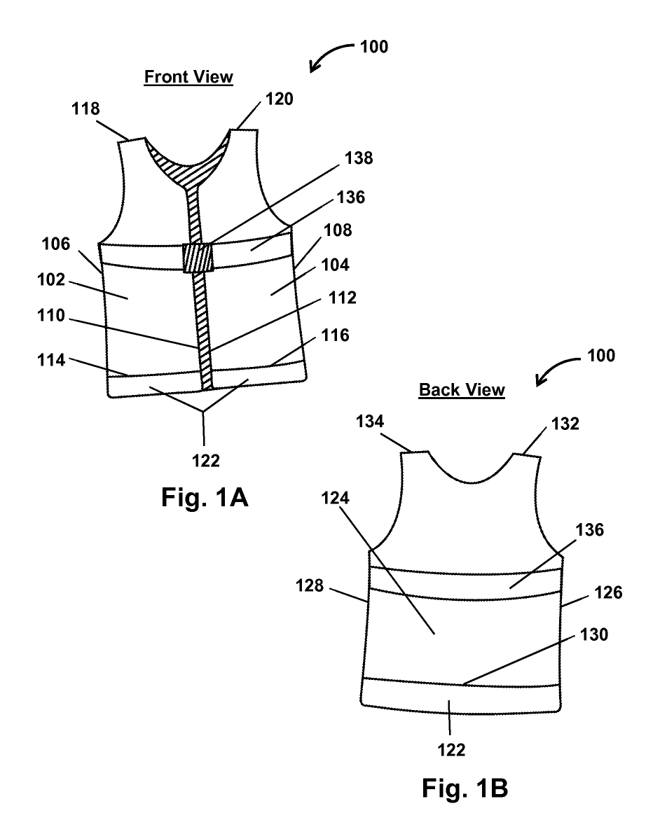

FIG. 1A and FIG. 1B illustrate a compression vest 100 for providing adjustable compression across a thoracic region of a subject, in accordance with one or more implementations. The thoracic region may describe a region of a body including one or more of a sternum, thoracic vertebrae, ribs, a heart, lungs, chest muscles, back muscles, tissue, blood vessels, and/or other anatomical aspects of the thoracic region of the subject. The thoracic region may include an abdominal-thoracic region. The abdominal-thoracic region may include the thoracic region and an abdominal region of a body including abdominal muscles, abdominal organs, tissue, blood, vessels, and/or other anatomical aspects of the abdominal region of the subject. Compression vest 100 may extend over and/or apply pressure to sections of the thoracic region of the subject. Sections of the thoracic region may include one or more of a section of a back, a section of a front torso, a section of a left side torso, a section of a right side torso, a section of a left shoulder, a section of a right shoulder, and/or other sections of the thoracic region.

In some implementations, compression vest 100 may include one or more of strap 136. Responsive to compression vest 100 being worn by the subject, strap 136 may be configured to wrap around a section of the back, a section of the front torso, a section of the left side torso, a section of the right side torso, and/or other sections of the thoracic region of the subject. In some implementations, a cinching mechanism 138 may be coupled to strap 136. Cinching mechanism 138 may be coupled to one or more given ends of strap 136. Cinching mechanism 138 may be configured to apply adjustable tension in strap 136. Responsive to compression vest 100 being worn by the subject, cinching mechanism 138 may be configured such that a thoracic region of the subject may be further compressed by the adjustable tension in the strap.

In some implementations, compression vest 100 may include one or more portions. The portions may be joined, attached, and/or detachably coupled at one or more edges. The one or more portions may include one or more of a left front portion 102, a right front portion 104, a back portion 124, a band portion 122, and/or other portions. The one or more edges may include one or more of a left outer edge 106, a right outer edge 108, a left inner edge 110, a right inner edge 112, a left bottom edge 114, a right bottom edge 116, a left top edge 118, a right top edge 120, a first outer edge 126, a second outer edge 128, a back bottom edge 130, a first top edge 132, a second top edge 134, and/or other edges.

Right front portion 104 may be formed of an elastic material. Right front portion 104 may include one or more edges, for example, right bottom edge 116, right inner edge 112, right outer edge 108, right top edge 120, and/or other edges. Responsive to compression vest 100 being worn by the subject, right portion 104 may extend over a section of a right side of the front torso, a section of the right side torso, a section of the right shoulder, and/or other sections of the subject. The section of the right side of the front torso of the subject may include part of a right side of a chest and/or ribs of the subject. The section of the right side torso may include a part of right side ribs and/or right side abdomen. In some implementations, the section of the right side torso may be just below a right axilla and/or armpit region of the subject. The section of the right shoulder of the subject may include a part of a right clavicle and/or part of an upper right side chest of the subject. Responsive to compression vest 100 being worn by the subject, right front portion 104 may be configured to extend across the right side of the chest, ribs, and/or abdomen of the subject and/or partially over the right shoulder of the subject.

Left front portion 102 may be formed of an elastic material. Left front portion 102 may include one or more edges, for example, left bottom edge 114, left inner edge 110, left outer edge 106, left top edge 118, and/or other edges. Responsive to compression vest 100 being worn by the subject, left portion 102 may extend over a section of a left side of the front torso, a section of the left side torso, a section of the left shoulder, and/or other sections of the subject. The section of the left side of the front torso of the subject may include part of a left side of a chest and/or ribs of the subject. The section of a left side torso may include a part of left side ribs and/or left side abdomen. In some implementations, the section of the left side torso may be just below a left axilla and/or armpit region of the subject. The section of the left shoulder of the subject may include a part of a left clavicle and/or part of an upper left side chest of the subject. Responsive to compression vest 100 being worn by the subject, left front portion 102 may be configured to extend across the left side of the chest, ribs, and/or abdomen of the subject and/or partially over the left shoulder of the subject.

Left front portion 102 may be configured to detachably couple to right front portion 104 at left inner edge 110 and right inner edge 112. Detachably couple may include attaching left front portion 102 to right front portion 104 such that the attachment can be removed, unattached, and/or undone. In some implementations, left inner edge 110 and right inner edge 112 may include one or more of and/or a portion of a coupling mechanism. For example, a coupling mechanism may include one or more fasteners. One or more fasteners may include one or more of a zipper, a hook and loop fastener, laces, a buckle, a buckle clip, and/or other fasteners. In some implementations, responsive to left front portion 102 being detachably coupled to right front portion 104, left inner edge 110 may meet, abut, and/or overlap with right inner edge 112. Detachably coupling left front portion 102 to right front portion 104 may secure compression vest 100 on the subject.

Back portion 124 may be formed of an elastic material. Back portion 124 may include one or more edges, for example, first outer edge 126, second outer edge 128, back bottom edge 130, first top edge 132, second top edge 134, and/or other edges of back portion 124. Responsive to compression vest 100 being worn by the subject, back portion 124 may extend over a section of the back, a section of the right side torso, a section of the left side torso, a section of the right shoulder, a section of the left shoulder, and/or other sections of the subject. The section of the back may include a part of a back of ribs and/or a spine of the subject. The section of a right side torso may include a back part of right side ribs and/or right side abdomen. In some implementations, the section of the right side torso may be just below the back of a right axilla and/or armpit region. The section of a left side torso may include a back part of left side ribs and/or left side abdomen. In some implementations, the section of the left side torso may be just below the back of a left axilla and/or armpit region. The section of the right shoulder of the subject may include a part of a right shoulder blade and/or part of an upper right back of the subject. The section of the left shoulder of the subject may include a part of a left shoulder blade and/or part of an upper left back of the subject. Responsive to compression vest 100 being worn by the subject, back portion 124 may be configured to extend across the back and/or partially over the back of the shoulders of the subject.

Back portion 124 may be configured to join left front portion 102 at first outer edge 126 and left outer edge 106. Back portion 124 may be configured to join right front portion 104 at second outer edge 128 and right outer edge 108. In some implementations, configured to join may include attached and/or coupled to. Back portion 124 may be attached and/or coupled to left front portion 102 and/or right front portion 104 via one or more of stitches, adhesive, a hook and loop fastener, a zipper, and/or other mechanisms. In some implementations, back portion 124 may be detachably coupled to left front portion 102 and/or right front portion 104. In some implementations, configured to join may include merge into, such that back portion 124 may merge into left front portion 102 and/or right front portion 104. For example, back portion 124, left front portion 102, and/or right front portion 104 may be a single piece of elastic material. In some implementations, back portion 124, left front portion 102, and/or right front portion 104 may include individual and/or multiple pieces of elastic material.

Left front portion 102 and/or right front portion 104 may be configured to detachably couple to back portion 124 at left top edge 118, right top edge 120, first top edge 132, and/or second top edge 134. Detachably couple may include attaching left front portion 102 and/or right front portion 104 at first top edge 132, left top edge 118, second top edge 134, and/or right top edge 120 such that the attachment can be removed, unattached, and/or undone. In some implementations, first top edge 132, left top edge 118, second top edge 134, and/or right top edge 120 may include one of more of and/or a portion of a coupling mechanism. For example, a coupling mechanism may include one or more fasteners, such as one or more of a hook and loop fastener, a snap, a button, a hook and eye closure, a zipper, ties, a buckle clip, a buckle, and/or other fasteners. In some implementations, responsive to left front portion 102 being detachably coupled to back portion 124, left top edge 118 may meet, abut, and/or overlap with first top edge 132. Responsive to right front portion 104 being detachably coupled to back portion 124, right top edge 120 may meet, abut, and/or overlap with second top edge 134.

In some implementations, left front portion 102, right front portion 104, back portion 124, and/or other portions may join, meet, attach, and/or detachably couple to form detachable shoulder straps. By way of non-limiting example, left front portion 102 may be detachably coupled to back portion 124 (e.g., via Velcro) forming a detachable left shoulder strap. Right front portion 104 may be detachably coupled to back portion 124 (e.g., via Velcro) forming a detachable right shoulder strap. Detachable shoulder straps may ease the donning of compression vest 100 by the subject. In some implementations, detachable shoulder straps may be formed by one or more, additional, and/or separate portions. Detachable shoulder straps may include one or more strap adjusters and/or slides for adjusting the length and/or tension in the detachable shoulder straps.

In some implementations, compression vest 100 may include band portion 122. Band portion 122 may be formed of an elastic material. Band portion 122 may be configured to join back portion 124, left front portion 102, right front portion 104, and/or other portions. Configured to join may include merge into such that band portion 122 may merge into back portion 124, left front portion 102, right front portion 104 and/or other portions. In some implementations, configured to join may include coupled to such that band portion 122 may be attached and/or coupled to back portion 124, left front portion 102, right front portion 104 and/or other portions via one or more of stitches, adhesive, a hook and loop fastener, a zipper, and or other mechanisms.

Band portion 122 may be configured to join back portion 124, left front portion 102, right front portion 104, and/or other portions at and/or near back bottom edge 130, left bottom edge 114, right bottom edge 116, and/or other edges. Responsive to compression vest 100 being worn by the subject, band portion 122 may be configured to extend around the subject. In some implementations, while compression vest 100 is worn by the subject, band portion 122 may help keep compression vest 100 from rolling, riding, inching and/or otherwise moving upwards on the subject. In some implementations, band portion 122 may be configured to extend around the subject under the abdominal portion of the subject such that abdominal tissue of the subject is lifted. As such, band portion 122 may help contain the abdominal tissue of a subject with a large abdominal section. Band portion 122 may be configured to have a thickness of greater than one half of an inch and/or another thickness. The thickness of band portion 122 may prevent rolling of band portion 122. Band portion 122 may include an elastic band. For example, the elastic band may be formed of an elastic material and/or contain elastic material.

In some implementations, compression vest 100 may be configured to have a length such that responsive to compression vest 100 being worn by the subject, band portion 122 may extend around the subject below a waist of the subject. Compression vest 100 may be configured to have a length such that responsive to compression vest 100 being worn by the subject, band portion 122 may extend around the subject at or above the waist of the subject. The waist of the subject may include a part of an abdomen of a subject between the rib cage and hips. In some subjects, the waist may be the narrowest portion of the torso and/or at or near the navel. For example, where band portion 122 extends around the subject above the waist of the subject, compression vest 100 may be configured to have a shorter length similar to that of a brasserie.

In some implementations, compression vest 100 may have one or more widths. A width may include a measurement from one side edge of compression vest 100 to the other side edge of compression vest 100. For example, the width of compression vest 100 may be the distance from left outer edge 106 to right outer edge 108. The width of compression vest 100 may vary at different points along the length of compression vest 100. For example, the width of compression vest 100 closer to the left top edge, right top edge, first top edge, and/or second top edge may be different than the width of compression vest 100 near the left bottom edge, right bottom edge, and/or back bottom edge.

In some implementations, compression vest 100 may have a lower chest width, a bottom width, and/or other widths. The lower chest width may be configured, responsive to compression vest 100 being worn by the subject, to include the width of compression vest 100 at a point at and/or just below a sternum of the subject. The bottom width may be configured, responsive to compression vest 100 being worn by the subject, to include the width of compression vest 100 at a point at and/or just below the waist of the subject. In some implementations, the lower chest width may be smaller than the bottom width. For example, the width of compression vest 100 may gradually increase from the lower chest width to the bottom width. In some implementations, the increased width may make compression vest 100 more secure and/or comfortable for overweight subjects and/or subjects having a larger midsection. The increased width may make compression vest 100 more secure by preventing compression vest 100 from rolling, scrunching, and/or riding up on overweight subjects. As such, compression vest 100 may provide stability to the abdominal-thoracic region of the subject.

Elastic material may include a flexibly resilient fabric. In some implementations, the elastic material may include anti-microbial properties. Responsive to compression vest 100 being worn by the subject, the elastic material may stretch, conform to the subject, and/or apply pressure to the thoracic region of the subject. The thoracic region of the subject may include the abdominal-thoracic region. In some implementations, elastic material may include a blend of nylon, spandex (e.g., Lycra®), and/or other elastic material. The blend of nylon, spandex, and/or other materials may be woven. In some implementations, the elastic material may be woven with one or more non-elastic materials.

Strap 136 may be coupled to compression vest 100. Strap 136 may be configured such that, responsive to the compression vest 100 being worn by the subject, strap 136 wraps around a section of the back, a section of the right side torso, a section of the left side torso, a section of the front torso (e.g., the chest), and/or other sections of the subject. Strap 136 may be formed of an elastic material. Strap 136 may include one or more ends such that responsive to compression vest 100 being worn by the subject, the strap wraps around the subject and one or more ends meet, abut, connect, couple to, and/or otherwise interact with the other one or more ends and/or portions of strap 136. In some implementations, a first end of strap 136 may include one of two ends of strap 136. A second end of strap 136 may include the other of two ends of strap 136. In some implementations, strap 136 may include fewer or more than two ends. For example, strap 136 may include one continuous strap having no ends. By way of non-limiting example, strap 136 may include four ends wherein at least two ends may meet, abut, connect, couple to, and/or otherwise interact.

Strap 136 may include a variety of lengths, shapes, and/or configurations. For example, strap 136 may have a uniform thickness, a varying thickness, a uniform circumference, a varying circumference, and/or other uniform or varying measurements. In some implementations, strap 136 may have straight and/or curved edges. For example, strap 136 may include thicker, curved sections for optimizing the distribution of pressure. Strap 136 may be thicker than three inches and/or thinner than three inches. In some implementations, strap 136 may include a combination of thick and thinner straps. By way of a non-limiting example, strap 136 may include a type of netting formed of an elastic material. In some implementations, strap 136 may include one or more pull cords, having one or more circumferences, that comprise all or a portion of strap 136.

In some implementations, strap 136 may be coupled to compression vest in one or more locations. Strap 136 may be coupled to compression vest 100 via one or more of a sleeve configured to encase strap 136, stiches, snaps, buttons, loops, and/or other coupling mechanisms. In some implementations, strap 136 may be held in place (e.g., across the sternum of a subject) via one or more holders. One or more holders may include one or more loops, adhesive, loopholes, eyelets, hoops, and/or other holders configured to hold strap 136 in place.

Strap 136 may be independently adjustable from compression vest 100. For example, strap 136 may be completely detachable from compression vest 100. Strap 136 may slide completely and/or partially freely across, through, on top of, underneath, and/or otherwise in relation to compression vest 100. In some implementations, strap 136 may include one or more sections. One or more sections of strap 136 may be coupled to compression vest 100 at one or more locations. In some implementations, compression vest 100 may include more than one of strap 136. Implementations having multiple straps may include multiple straps having the same configuration and/or multiple straps have different configurations. In some implementations, the length of strap 136 may be adjustable. For example, strap 136 may include one or more strap adjusters and/or slides for adjusting the length and/or tension in strap 136. In some implementations, responsive to strap 136 being completely detachable from compression vest 100, strap 136 may be swapped and/or exchanged for an alternate strap having a different compression level. As such, compression vest 100 coupled with different strap(s) 136 may allow for various stages of treatment.

Cinching mechanism 138 may be coupled to the first end and/or the second end of strap 136. Coupled to may include one or more of attached to, removably attached to, configured to control, and/or otherwise associated with. For example, a portion of cinching mechanism 138 may be attached to the first end of strap 136 and a portion of cinching mechanism 138 may be attached to the second end of strap 136. In some implementations, cinching mechanism 138 may be attached to compression vest 100 and/or configured to control the first end and/or the second end of strap 136. Cinching mechanism 138 may be located over a section of one or more of the left front portion 102, the right front portion 104, the back portion 124, and/or other portions of compression vest 100. As such, in some implementations, responsive to compression vest 100 being worn by the subject, cinching mechanism 138 may be centered (e.g., located over the sternum of the subject) and/or off-centered (e.g., located over a left or right pectoral region).

Cinching mechanism 138 may be configured to apply adjustable tension in strap 136. Adjustable tension may be applied in strap 136 by tightening strap 136 and/or securing strap 136 using cinching mechanism 138 and/or other tightening mechanisms. Adjustable tension may be applied in strap 136 such that responsive to compression vest 100 being worn by the subject, strap 136 and/or cinching mechanism 138 are configured to further compress a thoracic region of the subject.

Strap 136 and/or cinching mechanism 138 may be configured to provide additional adjustable compression across a surgical site located in a thoracic region of the subject. The surgical site located in the thoracic region of the subject may include a surgical site and/or wound associated with one or more of a sternectomy, a panniculectomy surgery, a coronary artery bypass surgery, a split thickness skin graft and/or closure revision surgery, a cardiac surgery, a plastic surgery, a post-mastectomy surgery, a post-tissue expander insertion surgery, a post-breast reduction surgery, and/or other surgeries involving the abdominal-thoracic region of the subject. In some implementations, compression vest 100, strap 136, and/or cinching mechanism 138 may increase immobilization of the thoracic region.

In some implementations, cinching mechanism 138 may include one or more of a buckle, a buckle clip, a hook and loop fastener, laces, a crank and/or ratchet closure, a cord lock, a hook and eye fastener, and/or other cinching mechanisms. For example, a crank and/or ratchet closure may include a Boa closure system and/or a similar system. A hook and loop fastener, for example, may include Velcro. By way of non-limiting example, a hook and eye fastener may include a hook with one or more corresponding eyes for various attachment location settings. In some implementations, cinching mechanism 138 may be a compound cinching mechanism including one or more cinching and/or closing mechanisms. For example, a Boa closure system may be used in conjunction with Velcro.

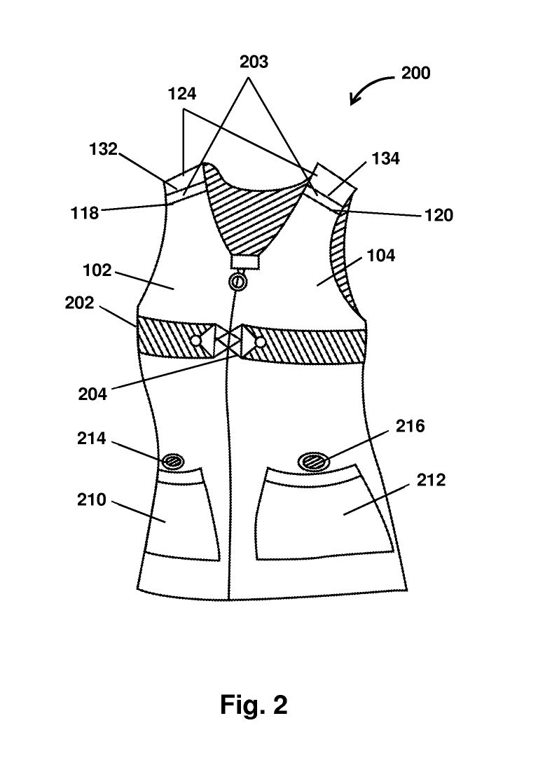

FIG. 2 illustrates an exemplary implementation of a post-operative compression vest 200 for providing adjustable compression across a thoracic region of a subject, in accordance with one or more implementations. Compression vest 200 may include a strap 202, a cinching mechanism 204, a first anterior pocket 210, a second anterior pocket 212, a first access hole 214, a second access hole 216, and/or other features. Cinching mechanism 204 may include one or more crank and/or ratchet closures. For example, cinching mechanism 204 may include a Boa closure system including one or more reels and/or steel cables coupled to strap 202 and/or compression vest 200. Cinching mechanism 204 may be centered, or offset towards the left or right. One or more of first anterior pocket 210, second anterior pocket 212, and/or other anterior pockets coupled to compression vest 200 may be configured, responsive to compression vest 200 being worn by the subject, to hold one or more of a drain tube, a heart monitor, excess cabling or tubing, and/or other objects. One or more anterior pockets 210,212 may be configured such that the top of the pocket, towards the opening, is narrower than the bottom of the pocket. One or more of first access hole 214, second access hole 216, and/or other access holes may be configured, responsive to compression vest 200 being worn by the subject to provide a hole for one or more of an existing drain tube, a monitor cable, and/or other attachments. In some implementations, first access hole 214, second access hole 216, and/or other access holes may include reinforced holes in compression vest 200.

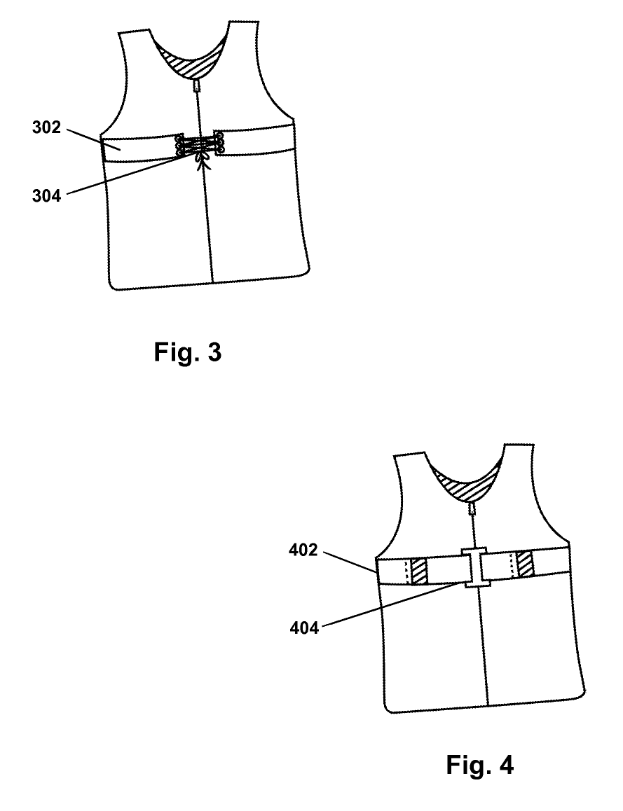

FIG. 3 illustrates an exemplary implementation of a post-operative compression vest 300 for providing adjustable compression across a thoracic region of a subject. Compression vest 300 may include a strap 302, a cinching mechanism 304, and/or other features. Cinching mechanism 304 may be centered, or offset towards the left or right. Cinching mechanism 304 may include one or more laces. For example, cinching mechanism 304 may include a lace system including one or more laces and/or one or more eyelets coupled to strap 302 and/or compression vest 300. The lace system may be configured such that when the laces are tightened and/or tied, strap 302 tightens and increases the compression across the thoracic region of the subject.

FIG. 4 illustrates an exemplary implementation of a post-operative compression vest 400 for providing adjustable compression across a thoracic region of a subject. Compression vest 400 may include a strap 402, a cinching mechanism 404, and/or other features. Cinching mechanism 404 may be centered, or offset towards the left or right. Cinching mechanism 404 may include one or more hook and loop fasteners. For example, cinching mechanism 404 may include Velcro coupled to one or more ends and/or portions of strap 402 and/or compression vest 400. Cinching mechanism 404 may include loops, slides, and/or other parts for use with strap 402 and/or the Velcro. For example, strap 402 may be tightened and secured (e.g., via Velcro) into a position that achieves the desired compression.

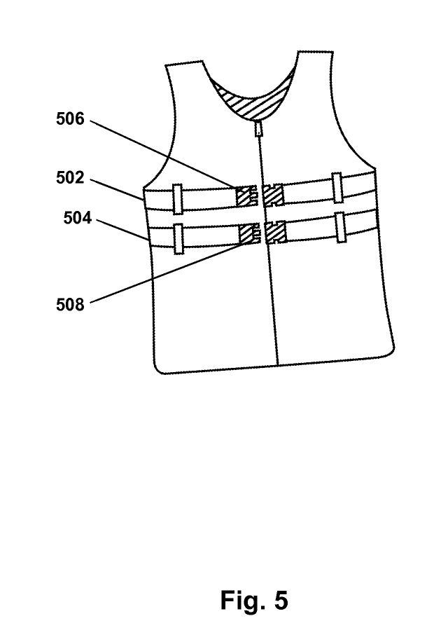

FIG. 5 illustrates an exemplary implementation of a post-operative compression vest 500 for providing adjustable compression across a thoracic region of a subject. Compression vest 500 may include a first strap 502, a second strap 504, a first cinching mechanism 506, a second cinching mechanism 508, and/or other features. First cinching mechanism 506 and/or second cinching mechanism 508 may be centered, or offset towards the left or right. By way of example, first cinching mechanism 506 and second cinching mechanism 508 may include one or more buckle clips. The female portion of one or more of the buckle clips may be attached to a first end of first strap 502 and/or a first end of second strap 504. The male portion of one or more of the buckle clips may be attached to a second end of first strap 502 and/or a second end of second strap 504. Responsive to compression vest 500 being worn by the subject, the male portions of the buckle clips may be inserted into the female portions of the buckle clips, securing first strap 502 and second strap 504. In some implementations, first strap 502 and second strap 504 may include one or more slides for adjusting the length and/or tension in first strap 502 and/or second strap 504 once the one or more buckle clips are secured. Adjusting the tension within first strap 502 and/or second strap 504 may provide multiple adjustable levels of compression across the thoracic region of the subject.

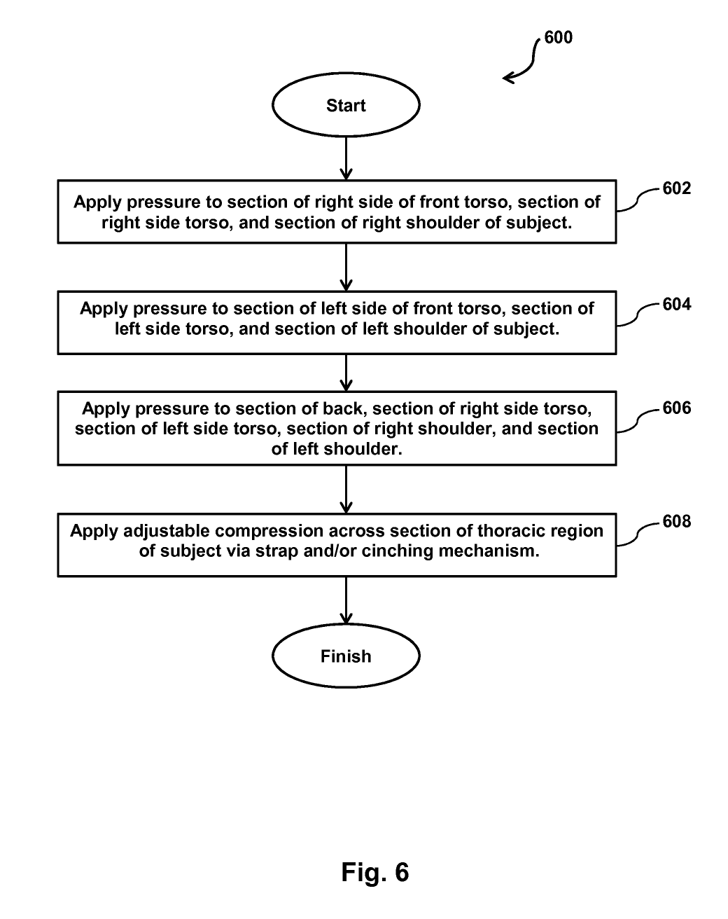

FIG. 6 illustrates a method 600 for applying adjustable compression across a thoracic region of a subject using a post-operative compression vest, in accordance with one or more implementations. The operations of method 600 presented herein are intended to be illustrative. In some implementations, method 600 may be accomplished with one or more additional operations not described, and/or without one or more of the operations discussed. Additionally, the order in which the operations of method 600 are illustrated in FIG. 6 and described herein is not intended to be limiting.

In some implementations, method 600 may be implemented using a post-operative compression vest. The compression vest may include a right front portion, a left front portion, a back portion, a strap coupled to the compression vest, a cinching mechanism coupled to the strap, and/or other features.

At operation 602, pressure may be applied to a section of a right side of a front torso, a section of a right side torso, and a section of a right shoulder of the subject. Operation 602 may be performed via a right front portion of a compression vest that is the same as or similar to right front portion 104 of compression vest 100, in accordance with one or more implementations.

At operation 604, pressure may be applied to a section of a left side of a front torso, a section of a left side torso, and a section of a left shoulder of the subject. Operation 604 may be performed via a left front portion of a compression vest that is the same as or similar to left front portion 102 of compression vest 100, in accordance with one or more implementations.

At operation 606, pressure may be applied to a section of a back, a section of a right side torso, a section of a left side torso, a section of a right shoulder, and a section of a left shoulder of the subject. Operation 606 may be performed via a back portion of a compression vest that is the same as or similar to back portion 124 of compression vest 100, in accordance with one or more implementations.

At operation 608, adjustable compression may be applied across a section of a thoracic region of the subject. Operation 608 may be performed via a strap and/or a cinching mechanism coupled to a compression vest and/or a strap that is the same as or similar to strap 136 and/or cinching mechanism 138 coupled to compression vest 100 and/or strap 136, in accordance with one or more implementations.

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

1. A medical compression vest configured to provide additional adjustable compression across a thoracic region of a subject, the medical compression vest comprising:
a right front portion formed of an elastic material, the right front portion having a right bottom edge, a right inner edge, a right outer edge, and a right top edge, the right front portion configured such that responsive to the medical compression vest being worn by the subject, the right front portion extends over a section of a right side of a front torso, a section of a right side torso, and a section of a right shoulder of the subject;
a left front portion formed of an elastic material, the left front portion having a left bottom edge, a left inner edge, a left outer edge and a left top edge, the left front portion configured such that responsive to the medical compression vest being worn by the subject, the left front portion extends over a section of a left side of a front torso, a section of a left side torso, and a section of a left shoulder of the subject, the left front portion configured to detachably couple to the right front portion at the left inner edge and the right inner edge;
a back portion formed of an elastic material, the back portion having a back bottom edge, a first outer edge, a second outer edge, a first top edge, and a second top edge, the back portion configured such that responsive to the medical compression vest being worn by the subject, the back portion extends over a section of a back, a section of a right side torso, a section of a left side torso, a section of a right shoulder, and a section of a left shoulder of the subject, the back portion joining the left front portion at the first outer edge and the left outer edge, and the back portion joining the right front portion at the second outer edge and the right outer edge, the back portion further being detachably coupled to the left front portion at the first top edge and the left top edge, and detachably coupled to the right front portion at the second top edge and the right top edge;
a strap coupled to the medical compression vest, the strap configured such that responsive to the medical compression vest being worn by the subject, the strap wraps around a section of a back, a section of a right side torso, a section of a left side torso, and a section of a chest of the subject; and
a cinching mechanism coupled to a first end and a second end of the strap, the cinching mechanism configured to apply adjustable tension in the strap such that, responsive to the medical compression vest being worn by the subject, a thoracic region of the subject is further compressed, wherein the cinching mechanism is configured such that responsive to the medical compression vest being worn by the subject, adjustment of the cinching mechanism applies additional, adjustable compression across a sternum of the subject.

2. The medical compression vest of claim 1, further comprising a band portion, the band portion joining the back portion, the left front portion, and the right front portion at the back bottom edge, the right bottom edge, and the left bottom edge, wherein the band portion is configured such that responsive to the medical compression vest being worn by the subject, the band portion extends around the subject.

3. The medical compression vest of claim 2, wherein the band portion is further configured such that, responsive to the medical compression vest being worn by the subject, the band portion extends around the subject, below the waist of the subject.

4. The medical compression vest of claim 2, wherein the band portion is further configured such that, responsive to the medical compression vest being worn by the subject, the band portion extends around the subject at or above the waist of the subject.

5. The medical compression vest of claim 2, wherein the band portion further comprises an elastic band, the elastic band having a thickness of greater than one half of an inch.

6. The medical compression vest of claim 1, wherein the medical compression vest is further configured to provide additional adjustable compression across a surgical site located in a thoracic region of the subject via the strap and/or cinching mechanism.

7. The medical compression vest of claim 1, wherein the medical compression vest further comprises a lower chest width and a bottom width, wherein the lower chest width is smaller than the bottom width.

8. The medical compression vest of claim 1, wherein the elastic material further comprises a blend of nylon and elastane.

9. The medical compression vest of claim 1, wherein the strap is formed of an elastic material.

10. The medical compression vest of claim 1, wherein the strap is further coupled to the medical compression vest via one or more holders configured to hold the strap in place, such that the strap is independently adjustable from the medical compression vest.

11. The medical compression vest of claim 1, wherein the cinching mechanism further comprises one or more of a buckle, a buckle clip, a hook and loop fastener, laces, a crank and/or ratchet closure, a cord lock, and/or a hook and eye fastener.

12. A method for applying adjustable compression across a thoracic region of a subject using a post-operative compression vest, the compression vest including a right front portion, a left front portion, a back portion, a strap coupled to the compression vest, and a cinching mechanism coupled to the strap, the method comprising:
applying pressure to a section of a right side of a front torso, a section of a right side torso, and a section of a right shoulder of the subject via the right front portion of the compression vest;
applying pressure to a section of a left side of a front torso, a section of a left side torso, and a section of a left shoulder of the subject via the left front portion of the compression vest;
applying pressure to a section of a back, a section of a right side torso, a section of a left side torso, a section of a right shoulder, and a section of a left shoulder of the subject via the back portion of the compression vest; and
applying adjustable compression across a section of a thoracic region of the subject via the strap and/or the cinching mechanism.

13. The method of claim 12, further comprising applying pressure to a section of a back, a section of a left side of a front torso, a section of a right side of a front torso, a section of a left side torso, and a section of a right side torso via a band portion of the compression vest.

14. The method of claim 13, wherein the section of a back, the section of a left side of a front torso, the section of a right side of a front torso, the section of a left side torso, and the section of a right side torso of the subject having pressure applied to via the band portion, are located below the waist of the subject.

15. The method of claim 13, wherein the section of a back, the section of a left side of a front torso, the section of a right side of a front torso, the section of a left side torso, and the section of a right side torso of the subject having pressure applied to via the band portion, are located at or above the waist of the subject.

16. The method of claim 13, further comprising applying pressure via a band portion wherein the band portion includes an elastic band, the elastic band having a thickness of greater than one half of an inch.

17. The method of claim 12, further comprising applying adjustable compression across a surgical site located in a thoracic region of the subject via the strap and/or cinching mechanism.

18. The method of claim 12, further comprising applying pressure via a compression vest, the compression vest including a lower chest width and a bottom width, wherein the lower chest width is smaller than the bottom width.

19. The method of claim 12, further comprising applying compression to the subject via a compression vest formed of an elastic material, wherein the elastic material includes a blend of nylon and spandex.

20. The method of claim 12, further comprising applying adjustable compression across a section of a thoracic region of the subject via the strap, wherein the strap is formed of an elastic material.

21. The method of claim 12, further comprising applying adjustable compression across a section of a thoracic region of the subject via the strap configured to be held in place on the compression vest via one or more holders, such that the strap is independently adjustable from the compression vest.

22. The method of claim 12, further comprising applying adjustable compression across a section of a thoracic region of the subject via the cinching mechanism coupled to the strap, wherein the cinching mechanism includes one or more of a buckle, a buckle clip, a hook and loop fastener, laces, a crank and/or ratchet closure, a cord lock, and/or a hook and eye fastener.

23. The medical compression vest of claim 1, wherein the cinching mechanism is offset such that responsive to the medical compression vest being worn by the subject, the cinching mechanism is disposed off-center to the left and/or right of a sternum of the subject.
